(19) United States
(12) Patent Application Publication
(10) Pub. No.: US 2010/0333034 A1
(43) Pub. Date: Dec. 30, 2010

(54) Handheld device, method, and computer program product for user selecting control component of application program

(75) Inventors: Michael Pierre Carlson, Austin, TX (US); Tony S.T. Hsu, Taipei (TW); Charles H. Lu, Taipei (TW)

Correspondence Address: Cuenot, Forsythe & Kim, LLC, 20283 State Road 7, Ste. 300, Boca Raton, FL, 33498, US

(73) Assignee: INTERNATIONAL BUSINESS MACHINES CORPORATION, Armonk, NY (US)

(21) Appl. No.: 12/822,684

(22) Filed: Jun. 24, 2010

(30) Foreign Application Priority Data
Jun. 26, 2009 (TW) 098121769

(51) Int. Cl. G06F 3/048

(52) U.S. Cl. 715/835

(57) ABSTRACT

Methods, systems, e.g., handheld device(s), and computer-program products are disclosed for a user selecting a control component, e.g., a control unit, of an application program. A plurality of available control components can be detected. A shortcut key can be assigned to each detected control component. The assigned shortcut key corresponding to each detected control component can be displayed. An instruction can be transmitted, responsive to one of the shortcut keys being initiated by the user, to the application program to select the corresponding control component.

### CROSS-REFERENCE TO RELATED APPLICATIONS

This application claims priority to Taiwan Patent Application Serial No. 098121769 entitled “HANDHELD DEVICE, METHOD AND COMPUTER PROGRAM PRODUCT FOR USER SELECTING CONTROL UNIT OF APPLICATION PROGRAM”, filed on Jun. 26, 2009. Taiwan Patent Application Serial No. 98121769 is fully incorporated within this specification by reference.

### TECHNICAL FIELD

The embodiments disclosed within this specification relate to a handheld device, a method, and a computer program product for user selection of control components of an application program. More particularly, the embodiments relate to a handheld device, a method, and a computer program product for user selection of control components of an application program using an intermediate module between an operating system and an application program.

### BACKGROUND

Recently, handheld devices, such as mobile phones, have become more popular and powerful. In the meantime, this increased power can become a barrier for users to learn the operation of the handheld device. For example, in addition to traditional voice communication, the mobile phone can provide a variety of applications, such as those relating to Internet accessibility. It is quite difficult for users to use applications when confined to using a limited number of buttons on the mobile phone, which leads to inefficient operation. The touch screen has been introduced as an alternative solution so that the user can use the application in a more instinctive way by simply touching the screen. However, a large number of mobile phones still are not equipped with a touch screen due to either design considerations or purposes of keeping costs down.

For the handheld device without a touch screen, the user can only utilize the few buttons thereon to operate applications, which can be very troublesome and inefficient.

### BRIEF SUMMARY OF THE INVENTION

Responsive to the above-mentioned issues and traditional techniques, several embodiments of the present invention are provided, such as a device, a method, and a computer program product for automatically selecting an Internet browser and providing Web service in order to improve one or more of the issues mentioned above.

Reference throughout this specification to features, advantages, or similar language does not imply that all of the features and advantages that can be realized as disclosed within this specification should be, or are, in any single embodiment. Rather, language referring to the features and advantages is understood to mean that a specific feature, advantage, or characteristic described in connection with an embodiment is included in at least one embodiment of the present invention. Thus, discussion of the features and advantages, and similar language, throughout this specification can, but does not necessarily, refer to the same embodiment.

Furthermore, the described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention.

One embodiment can include a method for a user selecting a control component from a plurality of control components of an application program within a handheld device. The method can include the following steps implemented by an intermediate module of the handheld device. The method can include detecting a plurality of available control components, respectively assigning a shortcut key to each detected control component, and respectively displaying the assigned shortcut key corresponding to each detected control component. An instruction can be transmitted, responsive to one of the shortcut keys being initiated by the user, to the application program to select the corresponding control component.

Another embodiment can include a handheld device having a processor, a display device, and an input device. The processor can be used for executing program code to provide the following modules: an operating system, an intermediate module, and an application program. The intermediate module can operate within the operating system and have a handling module and a graphic library. The application program can be operated within the intermediate module and access a plurality of control components by calling the graphic libraries. The display device can be used for displaying the plurality of control components. The input device can include a shortcut key in a predetermined quantity. The handling module can detect a plurality of available control components and respectively assign a shortcut key to each detected control component. The assigned shortcut key can be respectively displayed corresponding to each detected control component on the display device. The intermediate module can transmit an instruction, responsive to one of the shortcut keys being initiated by the user, to the application program to select the corresponding control component.

Another embodiment can include a computer program product including a computer readable storage medium having stored thereon computer readable program code that, when executed by a system having a processor, implements a method for a user to select a control component from a plurality of control components of an application program within a handheld device. The computer readable storage medium can include computer readable program code that detects a plurality of available control components, computer readable program code that respectively assigns a shortcut key to each detected control component, and computer readable program code that respectively displays the assigned shortcut key corresponding to each detected control component. The computer readable storage medium further can include computer readable program code that transmits an instruction, responsive to one of the shortcut keys being initiated by the user, to the application program to select the corresponding control component.

### BRIEF DESCRIPTION OF THE SEVERAL VIEWS OF THE DRAWINGS

In order for the advantages of the embodiments disclosed within this specification to be readily understood, a more particular description of the invention briefly described above will be rendered by reference to specific embodiments that are illustrated in the appended drawings. Understanding that these drawings depict only typical embodiments of the invention and are not, therefore, to be considered to be limiting in scope, the embodiments of the invention will be described and explained with additional specificity and detail through the use of the accompanying drawings.

FIG. 1 is an exemplary diagram of a handheld device according to an embodiment of the present invention.

FIG. 2 is a block diagram of a handheld device according to another embodiment of the present invention.

FIG. 3 is a flowchart illustrating a method according to another embodiment of the present invention.

FIGS. 4A to 4C are block diagrams illustrating a graphic user interface of the application program according to another embodiment of the present invention.

FIG. 5 is a flowchart illustrating a method according to another embodiment of the present invention.

FIG. 6 is an exemplary diagram of an intermediate module according to another embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification can, but do not necessarily, all refer to the same embodiment.

As will be appreciated by one skilled in the art, aspects of the present invention can be embodied as a system, method, or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied, e.g., stored, thereon.

Any combination of one or more computer readable medium(s) can be utilized. The computer readable medium can be a computer readable signal medium or a computer readable storage medium. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be any computer readable medium that is not a computer readable storage medium and that can communicate, propagate, or transport a program for use by or in connection with an instruction execution system, apparatus, or device.

Program code embodied on a computer readable medium can be transmitted using any appropriate medium, including but not limited to wireless, wireline, optical fiber, cable, RF, etc., or any suitable combination of the foregoing. Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The devices, methods, and computer program products are illustrated in the drawings as structural or functional block diagrams or process flowcharts according to various embodiments of the present invention. The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which comprises one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

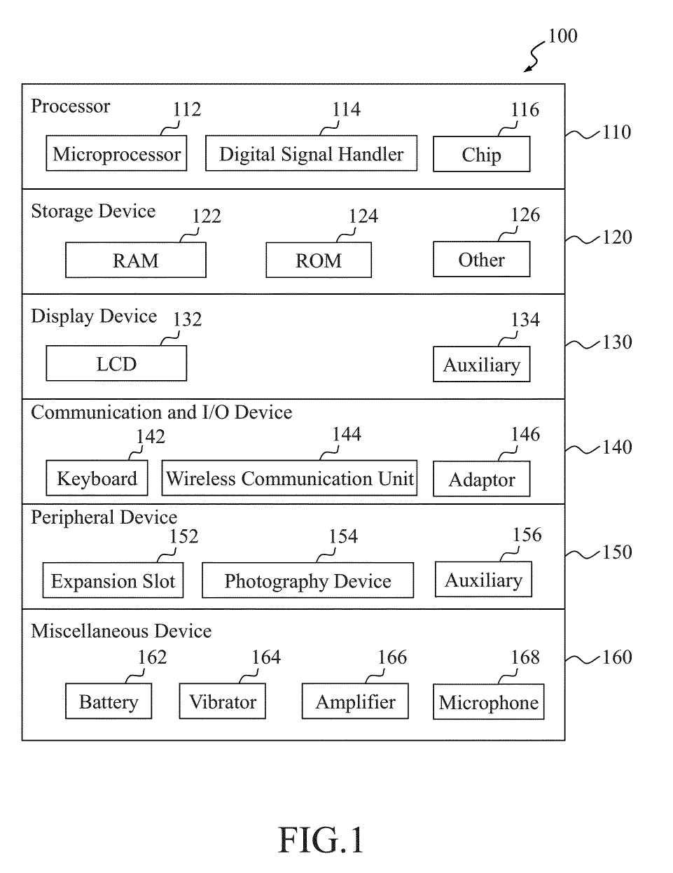

FIG. 1 is an exemplary diagram of handheld device according to one embodiment of the present invention. In this exemplary embodiment, handheld device 100 is a portable electronic product, such as mobile phone, PDA (personal digital assistant), GPS (global position system) device, media player, etc., capable of executing application programs for providing at least one of the following services: Internet, multimedia, document editing, or other applications. In FIG. 1, a handheld device 100 is shown for purposes of illustration so that those skilled in the art can understand an embodiment of the present invention. Accordingly, the examples provided are not intended to limit the embodiments disclosed. Handheld device 100 can include a processor 110, a storage device 120, a display device 130, a communication and input/output device 140, a peripheral device 150, and one or more miscellaneous device(s) 160. In other embodiments, however, more or less components can be embodied in accordance with the present invention. In this embodiment, the processor 110 can be a general purpose processing unit or a special purpose processing unit for handling analog/digital signal or executing program code for providing specific functions, such as microprocessor 112, digital signal handler 114, and other chips 116.

In this embodiment, the storage device 120 can include random access memory (RAM) 122 and read-only memory (ROM) 124 for storing program code or other data to be accessible to the handheld device 100. The storage device 120 can include other storage unit 126 for accessing and/or storing additional data, such as card reader, memory card, external disk arrays. The display device 130 can include LCD monitor 132 for displaying to the user the interface or other information of the operating system or the result of the executed application program. The display device 130 can have an auxiliary display unit 134 for providing other indications or information to the user, such as an LED light or the like.

In this embodiment, the communication and input/output device 140 can include a keyboard 142, a wireless communication unit 144, and adaptor 146. The keyboard 142 can be used as an input device for inputting instructions and/or data by the user, such as a digit pad, a QWERTY keypad, or other keyboard. In addition, the keyboard 142 can include other additional components, such as function keys, arrow keys, switches, radio buttons, knobs, joysticks, buttons or other elements for inputting data. The wireless communication unit 144 can be used to wirelessly transfer data, such as digital data transmissions or voice data transmissions to the base station by means of any kind of protocols, such as GSM, CDMA, SMS, MMS, WIFI, Bluetooth, IrDa (Infrared Data Association), etc. The adaptor 146 can provide a connection to external devices for transmitting data, such as IEEE 1394, USB, or other adaptors

In this embodiment, the peripheral device 150 can have an extra expansion slot 152 for providing addition functions; a photography device 154 for picture or video capture; and other auxiliary component(s) 156, such as a barcode scanner, RFID unit, etc. The miscellaneous device (or devices as the case may be) 160 can include other components, such as battery 162, vibrating element 164, amplifier 166, microphone 168, etc.

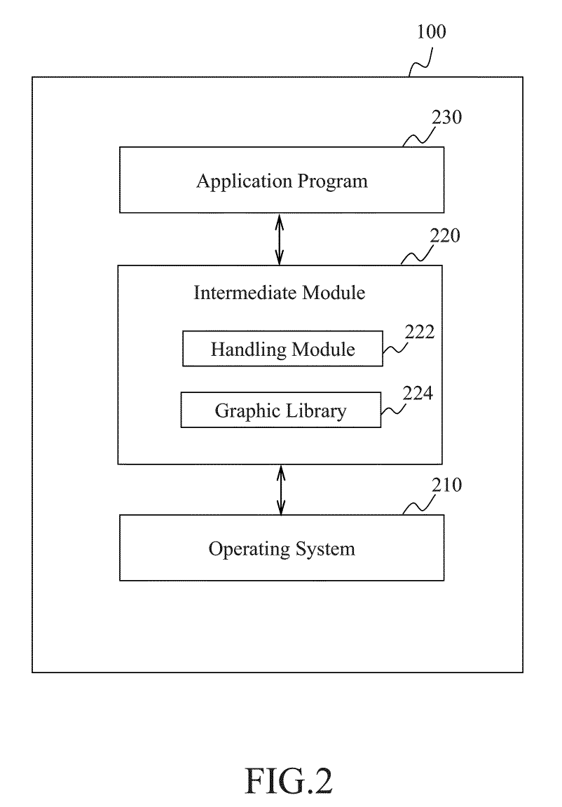

As mentioned above, the storage device 120 of the handheld device 100 can store the program code to be executed by the processor 110 for providing the functions of the handheld device 100. FIG. 2 is a block diagram of the handheld device 100 in accordance with one embodiment of the present invention for illustrating the functions provided by executing the program code. In this embodiment, the program code stored in the storage device 120 is executed by the processor 110 to provide an operating system 210, an intermediate module 220, and an application program 230, as shown in FIG. 2. The operating system 210 provides the fundamental functional and operating environment for the handheld device 100. Please note that the present invention is not limited to embodiments that use a specific operating system, but can be used in any operating system, such as Symbian™, Windows Mobile™, Android™, or the like.

The intermediate module 220 is run on the operating system 210 and includes a handling module 222 and a graphic library 224. In another embodiment, the intermediate module 220 can be integrated with, or embedded into, the operating system 210. In one embodiment, the graphic library 224 can be the Embedded Standard Widget Toolkit (eSWT) under the Java™ environment for providing certain control components. The “control component”, also called a “control unit” herein, means an element provided by the graphic library 224, also called a “Widget” or a “Control” in the field of programming of graphic user interfaces (GUIs), which will be further described within this specification. The application program 230 can be run on the operating system 210 or the intermediate module 220, and access the functions or resources by calling the library 224 or operating system 210. In this embodiment, the application program 230 can be a document editor. In other embodiments, the application program 230 can be any kind of application within the handheld device 100, such as an Internet browser, a media player, a game program, a calendar, an address book, etc.

It should be noted that many of the functional units described in this specification have been labeled as modules, in order to more particularly emphasize their implementation independence. For example, a module can be implemented as a hardware circuit comprising custom VLSI circuits or gate arrays, off-the-shelf semiconductors such as logic chips, transistors, or other discrete components. A module can also be implemented in programmable hardware devices such as field programmable gate arrays, programmable array logic, programmable logic devices, or the like. Modules can also be implemented in software for execution by various types of processors. An identified module of executable code can, for instance, comprise one or more physical or logical blocks of computer instructions, which can, for instance, be organized as an object, procedure, or function. Nevertheless, the executables of an identified module need not be physically located together, but can comprise disparate instructions stored in different locations which, when joined logically together, comprise the module and achieve the stated purpose for the module.

Indeed, a module of executable code can be a single instruction, or many instructions, and can even be distributed over several different code segments, among different programs, and across several memory devices. Similarly, operational data can be identified and illustrated herein within modules, and can be embodied in any suitable form and organized within any suitable type of data structure. The operational data can be collected as a single data set, or can be distributed over different locations including over different storage devices, and can exist, at least partially, merely as electronic signals on a system or network.

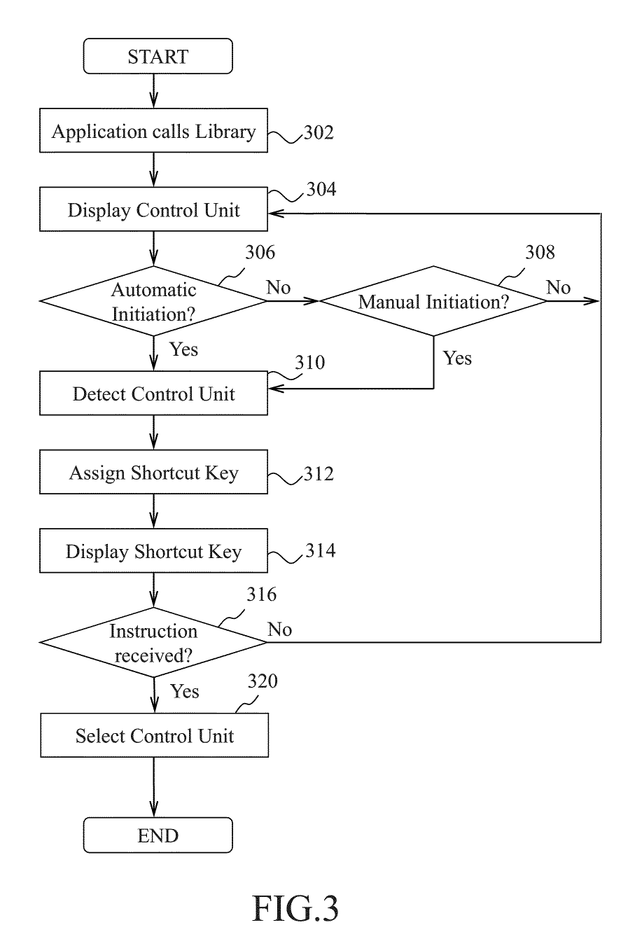

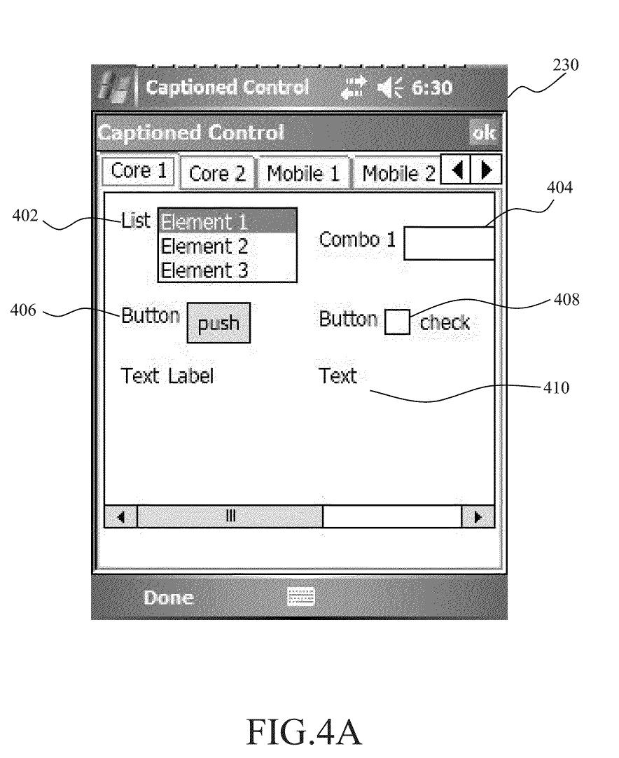

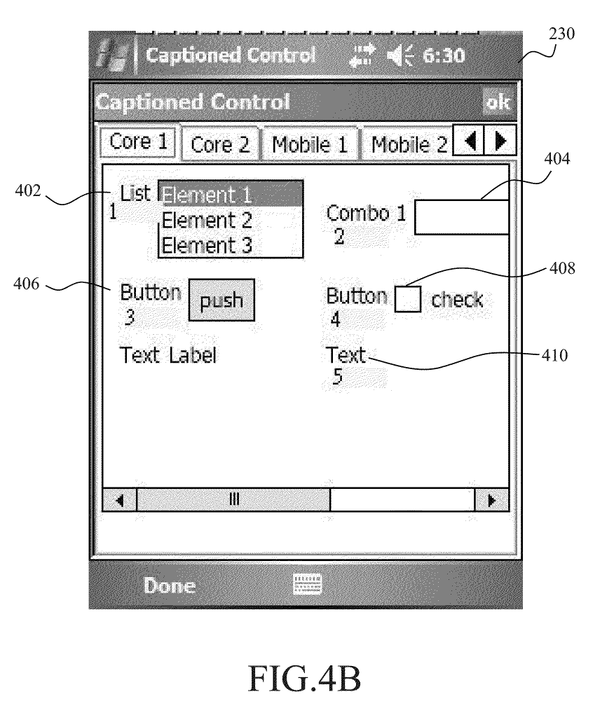

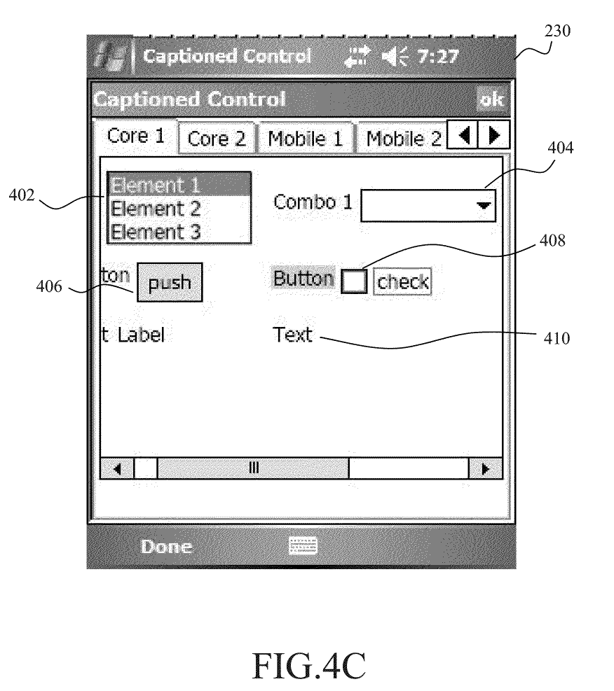

Below please refer to FIG. 3, which further illustrates a flowchart according to another embodiment of the present invention. In step 302, the application program 230 can access a plurality of control components by calling the graphic library 224 of the intermediate module 220. In step 304, the execution result of the application program 230 can be displayed by the display device 130, including the plurality of control components, such as the control components 402 to 410 as shown in FIG. 4A. FIG. 4A illustrates a user interface of the application program 230 having the control components from eSWT called by Lotus Expeditor™. The control components 402 to 410 are elements provided by GUI toolkits through which a user can select, configure, or input data. Each control component can have a specific function. For example, the control component 402 is a drop-down menu with several items; the control component 404 is a text input field; the control component 406 is a button; the control component 408 is a check box; and the control component 410 is another type of text input field. In a typical GUI in a personal computer, a user usually selects the control component using a pointing device, such as a mouse. Once the user selects a specific control component, the application program switches the active target to the selected control component. The selected control component is also called “Focused” or Active”. This kind of operation can be easily replaced by a touch screen so that the user can select the control component by simply touching the control component shown on the screen. For a handheld device without a touch screen, however, the user can use only the limited buttons on the keyboard 142, usually ten to twenty buttons on a typical handheld device. For example, the user has to push the arrow keys or switch keys on the handheld device at least three times to switch the focus from the control component 402 to the control component 410. If the application program has a more complex function with a large number of control components, the user has to waste a lot of time for just switching the focus to the control component he/she wants. For example, a typical Web page can contain dozens or even hundreds of control components on a single page.

In one embodiment, an efficient approach is disclosed for providing a more friendly operation and experience. In steps 306 and 308, the handling module 222 determines whether an automatic initiation or a manual initiation is enabled. If the automatic initiation is enabled, the handling module 222 can proceed to step 310 automatically following the loading, executing, and displaying of the application program 230. On the other hand, if the manual initiation is enabled, the handling module 222 can proceed to step 310 only after receiving an instruction from the user, such as a default button for initiating the handling module 222, e.g. “#” or “OK” button on a mobile phone. In step 310, the handling module 222 can detect the available control components. In this embodiment, the available control components mean all control components shown in a single page on the display device 130, such as the control components 402 to 410 as shown in FIG. 4A. In other embodiments, however, other control components in a scrollable page (even currently not shown on the screen) can also be defined as the available control components. In yet another embodiment, the available control components can be defined as all control components available to the application program 230 whether currently displaying on the screen or not. In other words, the available control components can be defined according to the actual situation and requirement without affecting the implementation of the embodiments of the present invention. Below the first kind of available control components is discussed for illustrative purposes.

In this embodiment, the handheld device 100 has a predetermined quantity of shortcut keys, i.e., the ten digit buttons from “0” to “9” on the keyboard 142. On the other hand, there are five detected control components in step 310, which is still within the quantity of shortcut keys. In step 312, the handling module 222 respectively assigns a shortcut key to each detected control component. For example, the shortcut key “1” can be assigned to the control component 402, the shortcut key “2” can be assigned to the control component 404, the shortcut key “3” can be assigned to the control component 406, the shortcut key “4” can be assigned to the control component 408, and the shortcut key “5” can be assigned to the control component 410.

In step 314, the handling module 222 can respectively display the assigned shortcut key corresponding to each detected control component on the display device 130. To display the shortcut key means displaying labels, symbols, characters, or marks, etc., on the display device 130 corresponding to the assigned shortcut key so that the user can identify the shortcut key assigned to each control component. In this embodiment, digits “1” to “5” can be displayed respectively near the control components 402 to 410, as shown in FIG. 4B. In addition, the digits for identifying the shortcut keys can be displayed in a background color different from that of the control components 402 to 410 so that the shortcut keys will not visually interfere and confuse the user. In other embodiments, the shortcut keys can be displayed in semi-transparent form, within a frame, in video, or any other way distinguishable from the application program 230.

After displaying the shortcut keys on the display device 130, the user can switch between the control components by simply pressing the corresponding shortcut keys. For example, if the user wants to switch from the control component 402 to the control component 408, the user can simply press the digit button “4” on the handheld device 100. The handling module 222 receives the instruction from the user in step 316 and then transmits a corresponding instruction to the application program 230 to select the control component 408 in step 320. For example, the control component 408 can be highlighted as shown in FIG. 4C, i.e., the word “Button” is highlighted in a different background color and the word “Check” is framed in a box. In addition, since the assignment and display of shortcut keys can be handled by the intermediate module 220 as mentioned above, the embodiments disclosed can be applied to any application program 230 by inserting the intermediate module 220 between the operating system 210 and application program 230, or by updating an existing intermediate module 220, without any modification to the application program 230. In this manner, a programmer can implement the embodiments described within this specification in virtually any handheld device. Further, any update or new function can be applied by modifying the intermediate module 220 without changing the application program 230.

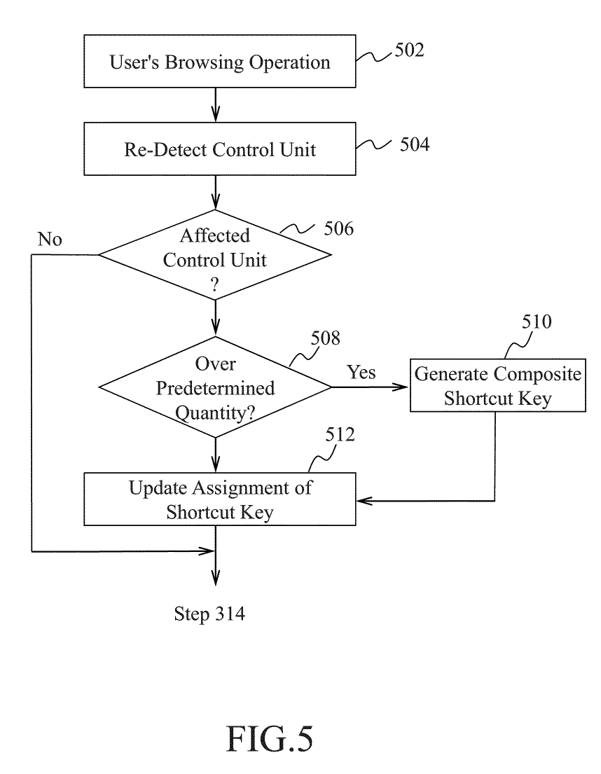

FIG. 5 further illustrates a flowchart in accordance with another embodiment of the present invention. In step 502, user can perform a browsing operation, such as flipping, scrolling, or refreshing the page. In responsive to the operation, the available control components on the screen can be affected. For example, some control components can be hidden, or otherwise made to disappear, and some new control components can be presented during the browsing operation. In step 504, the handling module 222 can re-detect the available control components. In step 506, the handling module 222 determines whether there is any control component affected during the browsing operation. If not, the method returns back to the step 314 in FIG. 3, which is omitted here for conciseness. If there is any control component affected, the handling module 222 determines whether the current available control components exceed the predetermined quantity of the shortcut keys, i.e., the number of shortcut keys on the handheld device 100. For example, if there are 11 available control components displayed on the screen, the handling module 222 will determine that the available control components exceed the 10 shortcut keys in this embodiment. Responsive to such a condition, the handling module 222 can generate and assign a composite shortcut key for the control component over the predetermined quantity. For example, the handling module 222 can generate a composite shortcut key with a “*” button plus any one of the digit buttons “0-9”. The user can select the control component by pressing two or more buttons in sequence or at the same time to select the control component. In other embodiments, other composite shortcut key(s) can be assigned, such as any combination of the buttons on the keyboard 142.

In step 512, the handling module 222 can update the shortcut keys. For example, five shortcut keys are already assigned to five available control components in an exemplary scenario. After the browsing operation, one of the control components can become unavailable and 7 control components can become available, e.g., newly added. The handling module 222 can release the shortcut key assigned to the control component that has become unavailable, and then assign the 6 shortcut keys and one new composite shortcut key to the 7 new control components. In another embodiment, the update of the shortcut keys can be implemented in a different sequence or different way. For example, the handling module 222 can release all shortcut keys previously assigned and then assign the shortcut keys to all control components detected during the re-detection step. In other words, the present invention does not limit the sequence and method for updating the shortcut keys.

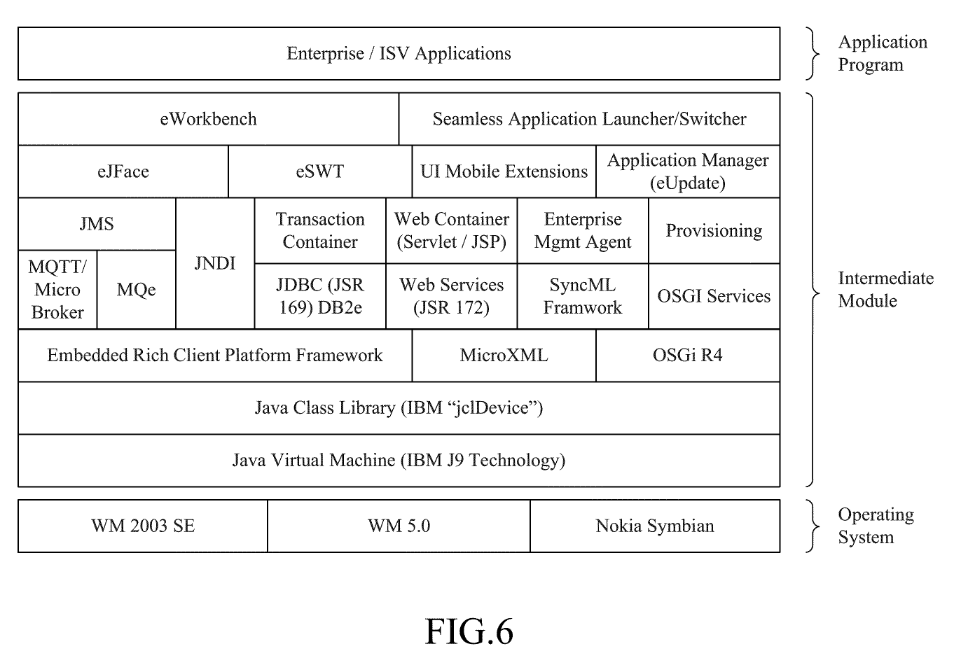

FIG. 6 illustrates a schematic view of the intermediate module in accordance with one embodiment of the present invention. In this embodiment, the “Seamless Application Launcher/Switcher” as shown in the drawing can be used as the handling module 222 and the “eSWT” as shown in the drawing can be used as the graphic library 224. In another embodiment, the intermediate module 222 can be implemented as any one of the modules, in whole or in part, as shown in FIG. 6, or in combination with other modules not shown in the drawings. In yet another embodiment, the handling module 222, graphic library 224, or any other modules, can be implemented through the modules as shown in FIG. 6 or be provided by the combination of the modules as shown in FIG. 6.

The terminology used herein is for the purpose of describing particular embodiments only and is not intended to be limiting of the embodiments presented. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The description within this specification is intended to illustrate the preferred embodiments of the present invention and is not intended to limit the scope of the embodiments disclosed. Any equivalent variations or modifications without departing from the spirit of the embodiments disclosed within this specification should be included in the appended claims. Accordingly, the description of the embodiments is not intended to be exhaustive or limiting of the embodiments in the form disclosed. Many modifications and variations will be apparent to those of ordinary skill in the art without departing from the scope and spirit of the invention. The embodiments were chosen and described in order to best explain the principles and the practical application of the embodiments, and to enable others of ordinary skill in the art to understand the embodiments with various modifications as are suited to the particular use contemplated.

What is claimed is:

1. A method for a user to select a control component from a plurality of control components of an application program within a handheld device, the method comprising:
detecting a plurality of available control components within a handheld device;
assigning a shortcut key to each detected control component;
displaying, via the handheld device, the assigned shortcut key corresponding to each detected control component; and
transmitting an instruction, responsive to one of the shortcut keys being initiated, to the application program to select the corresponding control component.

2. The method according to claim 1, wherein detecting a plurality of available control components within a handheld device further comprises:
re-detecting the plurality of available control components responsive to a browsing operation by the user; and
updating the shortcut key assigned to each control component determined through the re-detecting.

3. The method according to claim 2, wherein updating the shortcut key assigned to each control component determined through re-detecting further comprises:
identifying at least one of the plurality of available control components that is no longer available in consequence of the re-detecting as a first effected control component;
identifying at least one newly available control component that is available in consequence of the re-detecting as a second effected control component;
releasing the shortcut key assigned to the first effected control component; and
assigning a shortcut key to the second effected control component.

4. The method according to claim 2, wherein updating the shortcut key assigned to each control component determined through re-detecting further comprises:
identifying at least one of the plurality of available control components that is no longer available in consequence of the re-detecting as an effected control component; and
releasing the shortcut key assigned to the effected control component.

5. The method according to claim 2, wherein updating the shortcut key assigned to each control component determined through re-detecting further comprises:
identifying at least one newly available control component that is available in consequence of the re-detecting as an effected control component; and
assigning a shortcut key to the effected control component.

6. The method according to claim 2, wherein updating the shortcut key assigned to the detected control component further comprises:
releasing all assigned shortcut keys; and
assigning a shortcut key to each control found in the redetection.

7. The method according to claim 1, wherein assigning a shortcut key to each detected control component further comprises:
determining whether the amount of the detected control components is more than a predetermined quantity;
assigning a shortcut key for control components within the predetermined value; and
generating and assigning a composite shortcut key to each control component over the predetermined quantity.

8. A handheld device, comprising:
a processor for executing program code to provide the following modules:
an operating system;
an intermediate module, within the operating system, comprising a handling module and a graphic library;
an application program, within the intermediate module, accessing a plurality of control components by calling the graphic libraries;
a display device for displaying the plurality of control components; and
an input device having shortcut keys in a predetermined quantity,
wherein the handling module detects a plurality of available control components and assigns a shortcut key to each detected control component,
wherein the assigned shortcut keys are displayed corresponding to each detected control component on the display device, and
wherein the intermediate module transmits an instruction, responsive to one of the shortcut keys being initiated, to the application program to select the corresponding control component.

9. The handheld device according to claim 8, wherein the intermediate module further re-detects the plurality of available control components responsive to a browsing operation by the user and updates the shortcut key assigned to each control component that is determined from the re-detecting.

10. The handheld device according to claim 9, wherein the intermediate module identifies at least one of the plurality of available control components that is no longer available in consequence of the re-detecting as an effected control component and releases the shortcut key assigned to the effected control component.

11. The handheld device according to claim 9, wherein the intermediate module identifies at least one newly available control component that is available in consequence of the re-detecting as an effected control component and assigns a shortcut key to the effected control component.

12. The handheld device according to claim 9, wherein the intermediate module further identifies at least one of the plurality of available control components that is no longer available in consequence of the re-detecting as a first effected control component, identifies at least one newly available control component that is available in consequence of the re-detecting as a second effected control component, releases the shortcut key assigned to the first effected control component, and assigns a shortcut key to the second effected control component.

13. The handheld device according to claim 9, wherein the intermediate module releases all assigned shortcut keys and assigns a shortcut key to each control found in the re-detecting.

14. The handheld device according to claim 8, wherein the intermediate module further determines whether the amount of the detected control components is more than a predetermined quantity, assigns a shortcut key for control components within the predetermined value, and generates and assigns a composite shortcut key to each control component over the predetermined quantity.

15. A computer program product comprising:
a computer readable storage medium having stored thereon computer readable program code that, when executed by a system, implements a method for a user to select a control component from a plurality of control components of an application program within a handheld device, the computer readable storage medium comprising:
computer readable program code that detects a plurality of available control components;
computer readable program code that assigns a shortcut key to each detected control component;
computer readable program code that displays the assigned shortcut key corresponding to each detected control component; and
computer readable program code that transmits an instruction, responsive to one of the shortcut keys being initiated by the user, to the application program to select the corresponding control component.

16. The computer program product according to claim 15, wherein the computer readable program code that detects a plurality of available control components further comprises:
computer readable program code that re-detects the plurality of available control components responsive to a browsing operation by the user; and
computer readable program code that updates the shortcut key assigned to each control component determined through re-detecting.

17. The computer program product according to claim 16, wherein the computer readable program code that updates the shortcut key assigned to each control component through re-detecting further comprises:
computer readable program code that identifies at least one of the plurality of available control components that is no longer available in consequence of the re-detecting as an effected control component; and
computer readable program code that releases the shortcut key assigned to the effected control component.

18. The computer program product according to claim 16, wherein the computer readable program code that updates the shortcut key assigned to each control component through re-detecting further comprises:
computer readable program code that identifies at least one newly available control component that is available in consequence of the re-detecting as an effected control component; and
computer readable program code that assigns a shortcut key to the effected control component.

19. The computer program product according to claim 15, wherein the computer readable program code that detects a plurality of available control components further comprises:
computer readable program code that releases all assigned shortcut keys; and
computer readable program code that assigns a shortcut key to each control found in the re-detecting.

20. The computer program product according to claim 15, wherein the computer readable program code that assigns a shortcut key to each detected control component further comprises:
computer readable program code that determines whether the amount of the detected control components is more than a predetermined quantity;
computer readable program code that assigns a shortcut key for control components within the predetermined value; and
computer readable program code that generates and assigns a composite shortcut key to each control component over the predetermined quantity.
